(19) United States
(12) Patent Application Publication
(10) Pub. No.: US 2019/0384778 A1
(43) Pub. Date: Dec. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Masato ANDO, Kanagawa (JP); Tomoyuki ITO, Kanagawa (JP)

(73) Assignee: FUJI XEROX CO., LTD., Tokyo (JP)

(21) Appl. No.: 16/354,214

(22) Filed: Mar. 15, 2019

(30) Foreign Application Priority Data
Jun. 15, 2018 (JP) 2018-115011

(51) Int. Cl. G06F 16/28; G06F 16/22; G06F 16/2457

(52) U.S. Cl. CPC G06F 16/287; G06F 16/2457; G06F 16/2282

(57) ABSTRACT

An information processing apparatus includes an acquisition unit and an output unit. The acquisition unit acquires a first relations diagram and a second relations diagram in each of which plural items are connected to each other via arrows to represent relations between the plural items. The output unit outputs notification information that is a notification of a result of comparison between a first relation and a second relation. The first relation is a relation between a first pair of items included in the plural items in the first relations diagram. The second relation is a relation between a second pair of items included in the plural items in the second relations diagram. The second pair of items are the same as or similar to the first pair of items.

### CROSS-REFERENCE TO RELATED APPLICATIONS

This application is based on and claims priority under 35 USC 119 from Japanese Patent Application No. 2018-115011 filed Jun. 15, 2018.

### BACKGROUND

### (i) Technical Field

The present disclosure relates to an information processing apparatus and a non-transitory computer readable medium.

### (ii) Related Art

A known information processing apparatus is as follows (see Japanese Unexamined Patent Application Publication No. 2014-112340, for example). A first receiver receives a first quality function deployment chart (QFD). A second receiver receives a second QFD, which is different from the first QFD. An integrating unit integrates the first QFD and the second QFD into a third QFD. Concerning an axis of the first QFD and an axis of the second QFD having the same axis name, if part of an item name positioned in a highest hierarchical level of items associated with the axis of the first QFD coincides with part of an item name positioned in a highest hierarchical level of items associated with the axis of the second QFD and if a remaining part of the item name of the first QFD does not coincide with a remaining part of the item name of the second QFD, the integrating unit sets the consistent parts to be an item name in a highest hierarchical level of items on an associated axis of the third QFD and sets the inconsistent parts to be item names in a second highest hierarchical level of items on the associated axis of the third QFD.

### SUMMARY

A plurality of items are connected to each other via arrows to represent relations therebetween in a relations diagram. In a case where a plurality of such relations diagrams are compared with each other, it is considered to employ a configuration in which the plurality of relations diagrams are displayed side by side. However, if such a configuration is employed, it is difficult for a user to obtain a result of comparison between the relations between pairs of items in the plurality of relations diagrams.

Aspects of non-limiting embodiments of the present disclosure relate to making it easier for a user to obtain a result of comparison between the relations between pairs of items in the plurality of relations diagrams, than in a case where the plurality of relations diagrams are simply displayed side by side, in each of which the plurality of items are connected to each other via arrows to represent the relations therebetween.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an acquisition unit and an output unit. The acquisition unit acquires a first relations diagram and a second relations diagram in each of which a plurality of items are connected to each other via arrows to represent relations between the plurality of items. The output unit outputs notification information that is a notification of a result of comparison between a first relation and a second relation. The first relation is a relation between a first pair of items included in the plurality of items in the first relations diagram. The second relation is a relation between a second pair of items included in the plurality of items in the second relations diagram. The second pair of items are the same as or similar to the first pair of items.

### BRIEF DESCRIPTION OF THE DRAWINGS

An exemplary embodiment of the present disclosure will be described in detail based on the following figures, wherein:

FIG. 1 is a conceptual diagram illustrating exemplary configurations of modules according to the exemplary embodiment;

FIG. 2 illustrates a data structure example of a relations diagram information table;

FIG. 3 illustrates a data structure example of an item information table;

FIG. 4 illustrates a data structure example of an arrow information table;

FIG. 5 illustrates a system configuration example using the exemplary embodiment;

FIG. 6 illustrates an example of a technique for which a relations diagram and a spreadsheet are created;

FIG. 7 illustrates an example of the relations diagram;

FIG. 8 illustrates an example of the relations diagram;

FIG. 9 illustrates an example of the relations diagram;

FIG. 10 illustrates an example of the spreadsheet;

FIG. 11 illustrates an example of a process on the relations diagram according to the exemplary embodiment;

FIG. 12 illustrates an example of a process on the relations diagram according to the exemplary embodiment;

FIG. 13 is a flowchart illustrating an example of a process according to the exemplary embodiment;

FIGS. 14A to 14C illustrate examples of a conversion process and a determination process;

FIG. 15 illustrates an example of a process on a relations diagram according to the exemplary embodiment;

FIG. 16 illustrates an example of a process on a relations diagram according to the exemplary embodiment;

FIG. 17 is a flowchart illustrating an example of a process according to the exemplary embodiment;

FIGS. 18A and 18B illustrate an example of a list process and an item deletion process; and

FIG. 19 illustrates an example of a hardware configuration according to the exemplary embodiment.

### DETAILED DESCRIPTION

Hereinafter, an exemplary embodiment of the present disclosure will be described in detail with reference to the attached drawings.

In a typical system using complex physical phenomena, a large number of events are linked to each other like chains. For example, a resultant event, such as a final quality of a product, may be caused by a plurality of events, which are caused by a plurality of other events, and the plurality of other events are caused by a plurality of still other events. In such a complex system, a large number of qualities need to be assured, and the cause-and-effect relations between causes and effects are extremely complex. Accordingly, it is difficult to find a design item (cause) that assures a desired quality (effect), and a change in design value for assuring a certain quality may tend to adversely affect the other qualities.

To visualize and organize such complex cause-and-effect relations, for example, a relations diagram is used. The relations diagram represents the cause-and-effect relations by connecting the effects and their causes to each other via arrows, and a logic tree is a typical example. The relations diagram is suitably used for indicating the effects and their causes in detail, without omission and repetition.

Even if representing the relations between events in the same system, exactly the same relations diagrams are not always produced because users who create the relations diagrams recognize the relations between events differently depending on their professional roles and experiences, and it may therefore be necessary to compare a plurality of relations diagrams with each other. However, it is difficult to search for parts that are not matched, for example, in the relations diagrams in which a large number of events are linked to each other like chains.

Thus, according to the exemplary embodiment, the same or similar events are extracted from different relations diagrams, and a difference in relation is determined if a relation between the events is described. Then, as a result, a description stating that the relation is the same or different is displayed.

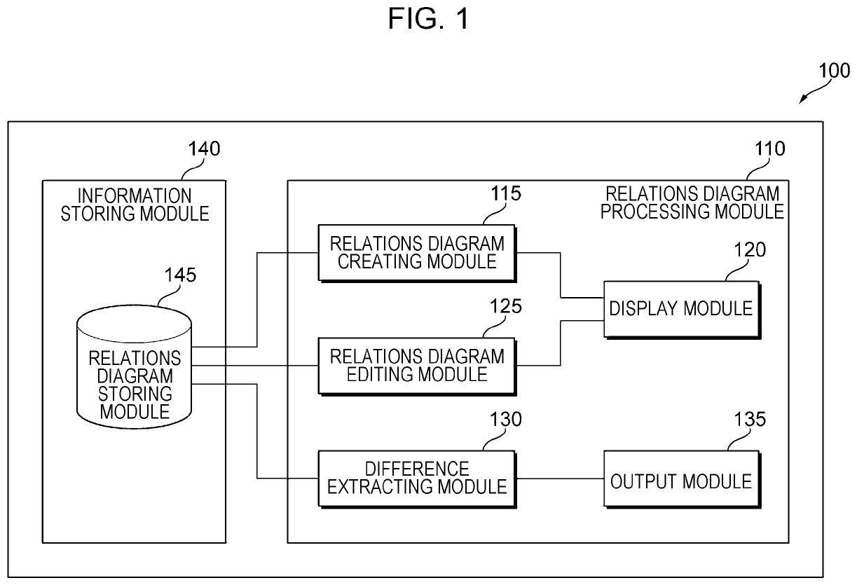

FIG. 1 is a conceptual diagram illustrating exemplary configurations of modules according to the exemplary embodiment.

Note that the term “module” generally means a logically separable component of software (computer program), hardware, or the like. Accordingly, a module in the exemplary embodiment refers to not only a module in a computer program but also a module in a hardware configuration. Therefore, the exemplary embodiment will also illustrate a computer program for realizing the function of such a module (a program for causing a computer to execute each step, a program for causing a computer to function as each unit, or a program for causing a computer to realize each function), a system therefor, and a method therefor. For the convenience of description, “store Y”, “cause X to store Y”, or a similar expression will be used. In an exemplary embodiment illustrating a computer program, such an expression means to cause a memory device (X) to store Y or to perform control in such a manner as to cause a memory device (X) to store Y. Modules and functions may correspond to each other in a one-to-one relationship. Alternatively, in implementation, a single program may realize a single module or a plurality of modules. Conversely, a plurality of programs may realize a single module. A plurality of modules may be executed by a single computer, or a single module may be executed by a plurality of computers in a distributed or parallel environment. In addition, a single module may include another module. The term “connect” is herein used to describe a physical connection or a logical connection (e.g., data transfer, instruction transmission, or data cross-reference). The term “predetermined” means a state where something is determined prior to a target process and includes the meaning of not only being determined before the starting of a process according to the exemplary embodiment but also being determined before the target process even after the starting of a process according to the exemplary embodiment, in accordance with the present or previous status and conditions. If there are a plurality of “predetermined values”, these values may be mutually different values, or two or more values may be the same (it is needless to say that all the values may be the same). Furthermore, a list of things such as “A, B, and C” is a list of examples unless otherwise specified, and only one of them (e.g., only A) may be selected therefrom.

Furthermore, a system or a device may be configured by connecting a plurality of computers, hardware components, devices, and the like to one another by using a communication means, such as a network (including one-to-one-correspondence communication connection), or may be configured by a single computer, hardware component, device, and the like. Note that the terms “system” and “device” are used as synonyms. It may be needless to say that the term “system” does not mean a social mechanism (social system), which is settled by humans.

Furthermore, in the case where a plurality of processes are performed by the respective modules or within a module, target information is read from a memory device in each process, and after the process has been performed, the process result is written to the memory device. Accordingly, description of the reading of information from the memory device before a process and the writing of information to the memory device after the process will be omitted in some cases. Note that examples of the memory device herein may include a hard disk, a random access memory (RAM), an external memory medium, a memory device connected via a communication line, a register in a central processing unit (CPU), and the like.

An information processing apparatus 100 according to the exemplary embodiment displays relations diagrams and, as illustrated in the example in FIG. 1, includes a relations diagram processing module 110 and an information storing module 140.

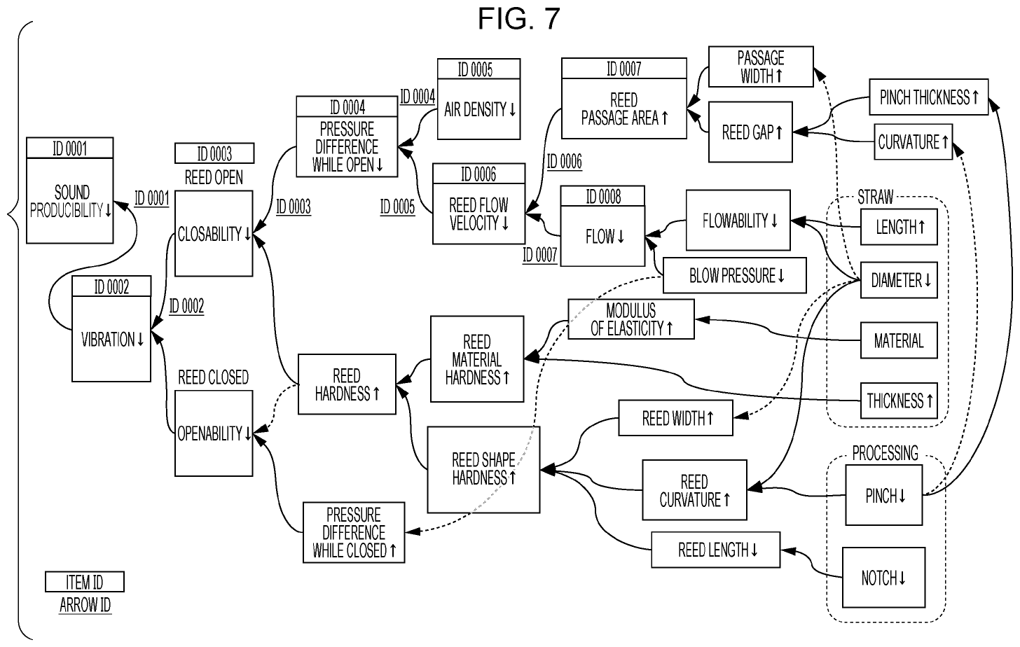

A relations diagram is used to clarify cause-and-effect relations when a problem to be addressed has been identified but causes of the problem are complex. As illustrated in FIG. 7, a relations diagram includes items and arrows.

The relations diagram processing module 110 includes a relations diagram creating module 115, a display module 120, a relations diagram editing module 125, a difference extracting module 130, and an output module 135. The relations diagram processing module 110 creates, edits, and displays a relations diagram, and outputs a difference between a plurality of relations diagrams.

The relations diagram creating module 115 is connected to the display module 120 and a relations diagram storing module 145 of the information storing module 140. The relations diagram creating module 115 receives information necessary to create a relations diagram. For example, the relations diagram creating module 115 receives information of a relations diagram, items, and arrows created by user operations, for example, using keys on a keyboard and a mouse, on a user interface displayed on a display device such as a liquid crystal display. The relations diagram creating module 115, not only receives user operations using keys on a keyboard and the like, but also reads information stored in a hard disk (e.g., a built-in hard disk of the computer or one connected through the network) or the like.

The display module 120 is connected to the relations diagram creating module 115 and the relations diagram editing module 125. The display module 120 displays a relations diagram created by the relations diagram creating module 115 and a relations diagram edited by the relations diagram editing module 125 on a display device such as a display. When the user performs no further operation on the display, the display module 120 may serve as an output module that prints the relations diagram by using a printing apparatus such as a printer, transmits an image by using an image transmitting apparatus such as a facsimile, writes the relations diagram in a storing apparatus such as a database, stores the relations diagram in a memory medium such as a memory card, or transfers the relations diagram to another information processing apparatus.

The relations diagram editing module 125 is connected to the display module 120 and the relations diagram storing module 145 of the information storing module 140. In response to a user operation for editing the relations diagram displayed by the display module 120, the relations diagram editing module 125 edits the relations diagram. For example, in response to a user's editing operation, the relations diagram editing module 125 edits (adds or deletes) an item, edits an attribute (name, characteristic, and the like) of the item, reassigns (adds or deletes) an arrow, and edits an attribute (strength, direction, and the like) of the arrow.

The difference extracting module 130 is connected to the output module 135 and the relations diagram storing module 145 of the information storing module 140. The difference extracting module 130 acquires two relations diagrams (a first relations diagram and a second relations diagram) that are targets to be compared with each other, searches for the same or similar items in the first relations diagram and the second relations diagram, and compares a pair of items including two items in the first relations diagram and a pair of items including two items in the second relations diagram with each other, so as to extract a difference between attributes of arrows or a difference between structures of arrows (e.g., hierarchical structures). Note that a difference between attributes of items may alternatively be extracted. Alternatively, the difference extracting module 130 may search for an arrow having the same or similar attribute in each of the first relations diagram and the second relations diagram and may compare the arrows with each other so as to extract a difference between attributes of arrows or a difference between structures of arrows (e.g., hierarchical structures). Note that a difference between attributes of items may alternatively be extracted.

The two relations diagrams that are targets to be compared with each other herein may be acquired by a user specifying both the first relations diagram and the second relations diagram. Alternatively, one of the two relations diagrams may be acquired by a user specifying one of the first relations diagram and the second relations diagram, and a predetermined logic may be executed on the basis of the one of the two relations diagrams so as to acquire the other relations diagrams. In addition, the first relations diagram and the second relations diagram may be identical with each other. In the exemplary embodiment, the difference extracting module 130 is provided as an example of an acquisition means for acquiring the first relations diagram and the second relations diagram.

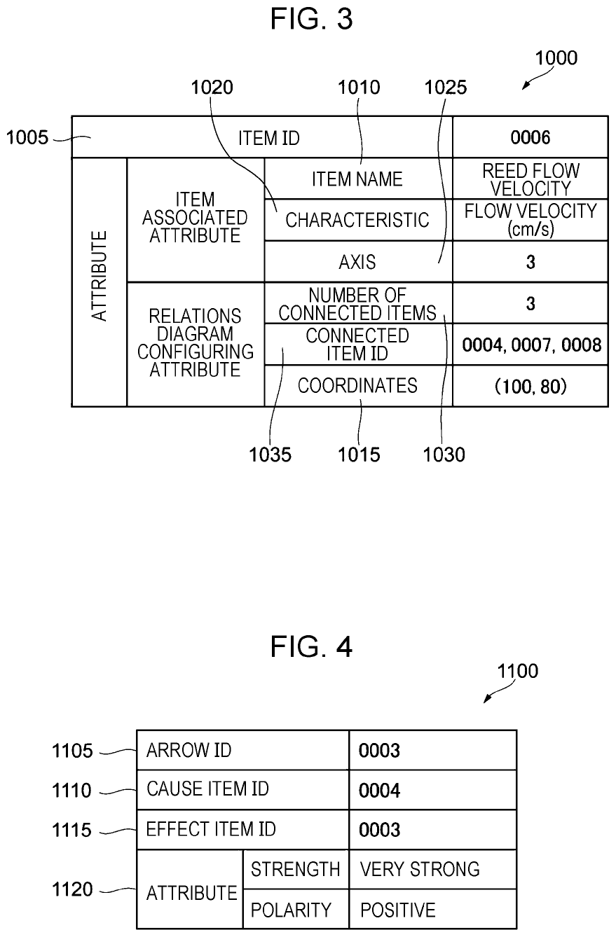

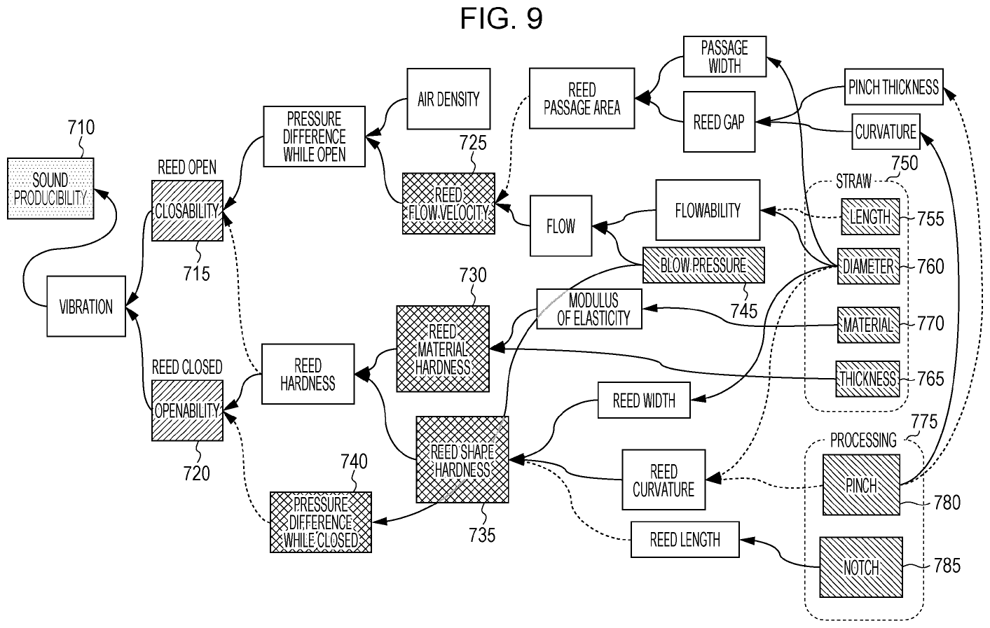

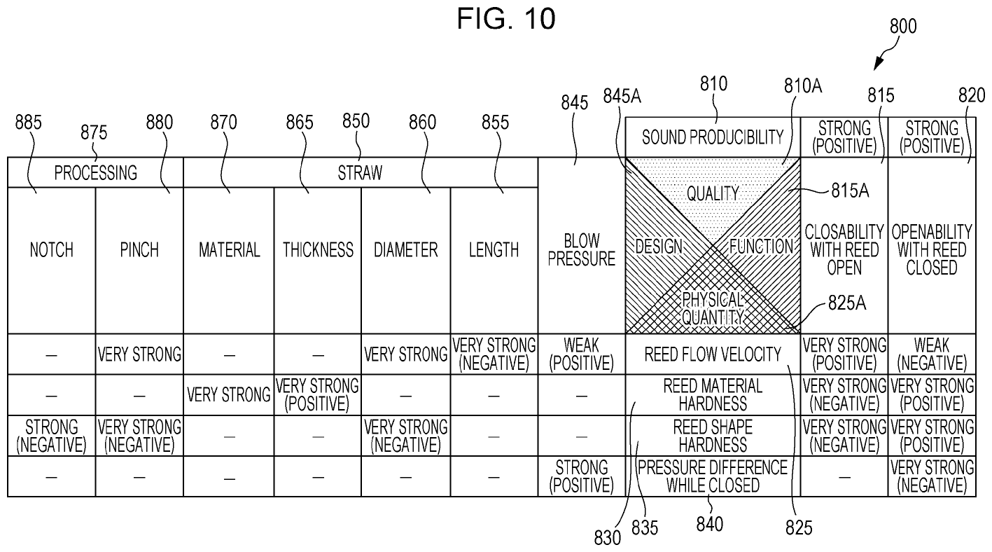

Note that the expression “items are the same” herein means that all of the names and characteristics of the items and the axes associated with the items (see FIG. 3) are the same in the first relations diagram and the second relations diagram, for example. The expression “the characteristics are the same” includes, for example, having equal values as a result of unit conversion. The expression “items are similar” herein means that at least one of the names and characteristics of the items and the axes associated with the items (see FIG. 3) is similar but the others are the same in the first relations diagram and the second relations diagram, for example. In this case, the expression “the names of the items are similar” means that the names of the items are partly the same or that one of the names of the items is rewording of the other (using a different expression without changing the meaning), for example. The expression “the characteristics are similar” means that the characteristics are partly the same, for example. The expression “the characteristics are partly the same” means that the expressions of the names of the characteristics are partly the same, as in “air flow rate” and “liquid flow rate”. In addition, similar characteristics or similar units may be stored in advance, and on the basis of these, similar characteristics may be determined. The expression “the axes associated with the items are similar” means that a difference between axes numerals is less than or equal to a predetermined value. If the predetermined value is 1, for example, axes 2 and 3 are determined as being “similar” (see FIGS. 9 and 10). Note that it may be determined that “items are similar” on the basis of a standard set by a user or by executing a predetermined logic by setting standard similar patterns. In the exemplary embodiment, a pair of items in the first relations diagram are used as an example of a first pair of items, and a pair of items in the second relations diagram are used as an example of a second pair of items that are the same as or similar to the first pair of items.

The output module 135 is connected to the difference extracting module 130. On the basis of information of a difference between attributes of arrows or a difference between hierarchical structures extracted by the difference extracting module 130, the output module 135 outputs information indicating a part where an attribute of an arrow or a hierarchical structure is the same in the first relations diagram and the second relations diagram or information indicating a part where an attribute of an arrow or a hierarchical structure is different in the first relations diagram and the second relations diagram. Note that a difference between attributes of items may alternatively be output.

The expression “a hierarchical structure is the same” herein means that the number and attributes of items connected via arrows are the same, for example. The expression “a hierarchical structure is different” means that a different item is present in the arrangement of the same or similar items connected via arrows, for example. Specific examples will be described later. For generalization, the expression “a hierarchical structure is different” may also mean that a number of items connected via arrows is different or that an attribute of items connected via arrows is different even if the number of items is the same. In the exemplary embodiment, as an example of notification information that is a notification of a result of comparison between a first relation and a second relation, the first relation being a relation between the first pair of items, the second relation being a relation between the second pair of items, information indicating a part where an attribute of an arrow or a hierarchical structure is the same or information indicating a part where an attribute of an arrow or a hierarchical structure is different is used. As an example of first notification information that is a notification stating that the first relation between the first pair of items and the second relation between the second pair of items are the same, information indicating a part where an attribute of an arrow or a hierarchical structure is the same is used. As an example of the first notification information that is a notification stating that an attribute of an arrow between the first pair of items and an attribute of an arrow between the second pair of items are the same, information indicating a part where an attribute of an arrow is the same is used. As an example of the first notification information that is a notification stating that a structure of the arrow between the first pair of items and a structure of the arrow between the second pair of items are the same, information indicating a part where a hierarchical structure is the same is used. As an example of second notification information that is a notification stating that the first relation between the first pair of items and the second relation between the second pair of items are different, information indicating a part where an attribute of an arrow or a hierarchical structure is different is used. As an example of the second notification information that is a notification stating that the attribute of the arrow between the first pair of items and the attribute of the arrow between the second pair of items are different, information indicating a part where an attribute of an arrow is different is used. As an example of the second notification information that is a notification stating that the structure of the arrow between the first pair of items and the structure of the arrow between the second pair of items are different, information indicating a part where a hierarchical structure is different is used.

In addition, the term “output” includes, for example, displaying a display element on a display device such as a display, print by using a printing apparatus such as a printer, transmission of an image by using an image transmitting apparatus such as a facsimile, writing in a storing apparatus such as a database, storing in a memory medium such as a memory card, and transfer to another information processing apparatus. In the exemplary embodiment, the output module 135 is provided as an example of an output means for outputting the notification information, the first notification information, and the second notification information.

The information storing module 140 includes the relations diagram storing module 145. The information storing module 140 stores information regarding the relations diagram.

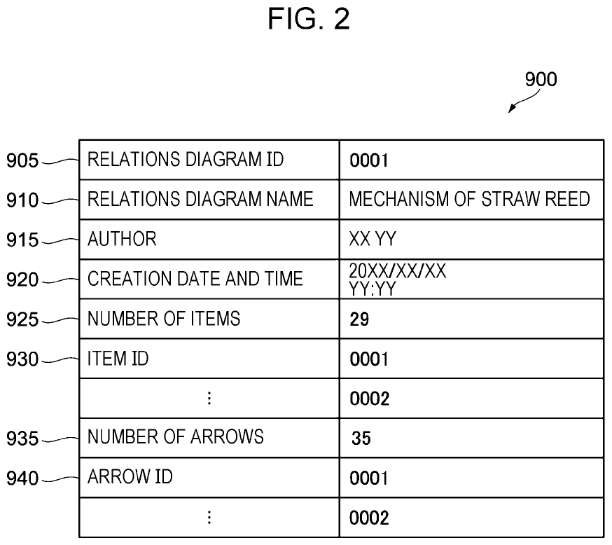

The relations diagram storing module 145 stores information of the relations diagram. Specifically, the relations diagram storing module 145 stores a relations diagram information table 900, an item information table 1000, and an arrow information table 1100. FIG. 2 illustrates a data structure example of the relations diagram information table 900. The relations diagram information table 900 includes a relations diagram ID field 905, a relations diagram name field 910, an author field 915, a creation date and time field 920, a number of items field 925, item ID fields 930, a number of arrows field 935, and arrow ID fields 940. In the exemplary embodiment, the relations diagram ID field 905 stores information for uniquely identifying a relations diagram (relations diagram identifier (ID)). The relations diagram name field 910 stores a name of the relations diagram having the relations diagram ID. The author field 915 stores an author of the relations diagram. The creation date and time field 920 stores a date and time point at which the relations diagram has been created or edited (year, month, day, hour, minute, second, decimal, or a combination thereof). The number of items field 925 stores the number of items in the relations diagram. There are as many item ID fields 930 as the number of items indicated in the number of items field 925. In the exemplary embodiment, the item ID fields 930 store information (item IDs) for uniquely identifying items. The information indicated by the item IDs is stored in the item information table 1000. The number of arrows field 935 stores the number of arrows in the relations diagram. There are as many arrow ID fields 940 as the number of arrows indicated in the number of arrows field 935. In the exemplary embodiment, the arrow ID fields 940 store information (arrow IDs) for uniquely identifying arrows. The information indicated by the arrow IDs is stored in the arrow information table 1100.

FIG. 3 illustrates a data structure example of the item information table 1000. The item information table 1000 is prepared for each item ID, and includes, as attributes, an item associated attribute that is an attribute associated with an item and a relations diagram configuring attribute that is an attribute for configuring a relations diagram. The item associated attribute is an attribute such as the name and characteristic of the item or an axis associated with the item. Note that the characteristic herein is a nature, a behavior, and an effect. The relations diagram configuring attribute is an attribute such as a number of connection items, a connection item ID, or coordinates. Along with this, the item information table 1000 includes an item ID field 1005, an item name field 1010, a coordinates field 1015, a characteristics field 1020, an axis field 1025, a number of connected items field 1030, and a connected item ID field 1035. The item ID field 1005 stores an item ID. The item name field 1010 stores a name of an item having the item ID. The coordinates field 1015 stores coordinates of the relations diagram at which the item is displayed. The characteristics field 1020 stores the characteristic of the item. The axis field 1025 stores an axis associated with an axis item corresponding to the item when the relations diagram is converted to a spreadsheet. The number of connected items field 1030 stores the number of items to which the subject item is connected. That is, the number of connected items field 1030 stores the total number of items serving as effects in a case where the subject item serves as a cause of connections and items serving as causes in a case where the subject item serves as an effect of connections. The connected item ID field 1035 stores IDs of items serving as the effects and IDs of items serving as the causes, and the number of the IDs of items is equal to the number of items indicated in the number of connected items field 1030. For example, a reed flow velocity is represented as follows: the item ID is “0006”, the item name is “reed flow velocity”, the characteristic is “flow velocity (cm/s)”, the axis is “3”, the number of connected items is “3”, the connected item IDs are “0004, 0007, 0008”, and the coordinates are “(100,80)”.

FIG. 4 illustrates a data structure example of the arrow information table 1100. The arrow information table 1100 includes an arrow ID field 1105, a cause item ID field 1110, an effect item ID field 1115, and an attribute field 1120. The arrow ID field 1105 stores an arrow ID. The cause item ID field 1110 stores an item ID of an item from which an arrow extends. The effect item ID field 1115 stores an item ID of an item to which the arrow extends. The attribute field 1120 stores an attribute of the arrow. The attribute can be, for example, a polarity of the arrow. The polarity is a nature as to whether a numeric value of an item serving as an effect increases as a numeric value of an item serving as a cause increases (e.g., in direct proportion) or whether a numeric value of an item serving as an effect decreases as a numeric value of an item serving as a cause increases (e.g., in reverse proportion). The attribute can also be, for example, the strength or direction of a relation indicated by the arrow.

FIGS. 2 to 4 illustrate examples, and other types of data structure may be used, instead. For example, the data structure of a graph may be used.

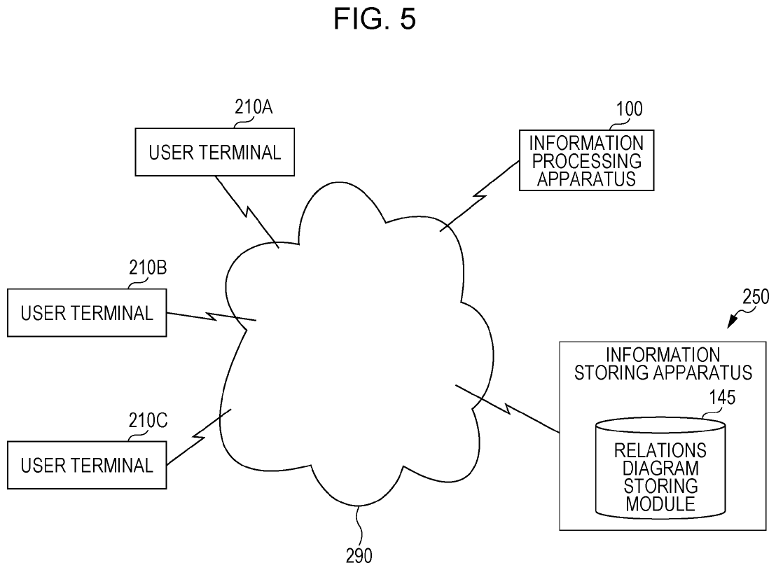

FIG. 5 illustrates a system configuration example according to the exemplary embodiment.

The information processing apparatus 100, a user terminal 210A, a user terminal 210B, a user terminal 210C, and an information storing apparatus 250 are connected to one another through a communication line 290. The communication line 290 may be a wireless or wired line or a combination of wireless and wired lines, and may be, for example, the Internet or an intranet as a communication infrastructure. Functions of the information processing apparatus 100 and the information storing apparatus 250 may be achieved as a cloud service. The information storing apparatus 250 includes the relations diagram storing module 145. The information processing apparatus 100 may use, as the relations diagram storing module 145, the relations diagram storing module 145 of the information storing apparatus 250 through the communication line 290.

The information processing apparatus 100 creates the first relations diagram in accordance with a user operation using the user terminal 210A, for example. Information of the relations diagram is stored in the relations diagram storing module 145 of the information storing apparatus 250 through the communication line 290.

The information processing apparatus 100 creates the second relations diagram in accordance with a user operation using the user terminal 210B, for example. Information of the relations diagram is stored in the relations diagram storing module 145 of the information storing apparatus 250 through the communication line 290.

For example, a user of the user terminal 210C mainly analyzes a difference between relations diagrams created by different users. Upon an instruction for displaying the difference between the first relations diagram and the second relations diagram from the user terminal 210C, the information processing apparatus 100 displays the difference on the user terminal 210C.

The user terminals 210A to 210C may include the information processing apparatus 100. In this case, a standalone system is established.

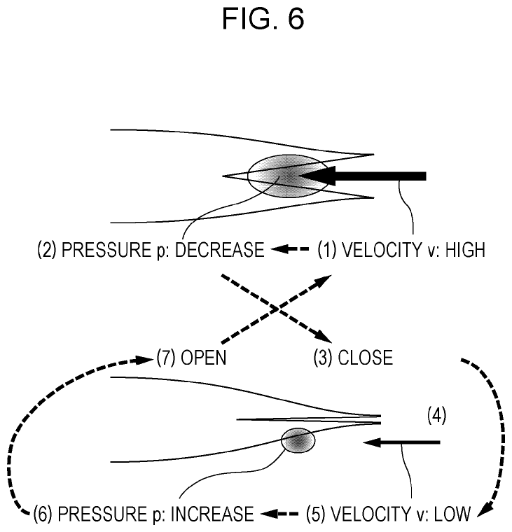

Next, with reference to FIGS. 6 to 10, an example of a mechanism of a straw reed will be described, in which a relations diagram is created and a spreadsheet is generated.

FIG. 6 illustrates an example of a technique (the mechanism of the straw reed) for which a relations diagram and a spreadsheet are created.

A principle in fluid dynamics stating that an increase in the speed of a fluid occurs simultaneously with a decrease in pressure, which is Bernoulli's principle (refer to expression (1)), is used.

p+½ρν²=constant(p:pressure, r:density, v:velocity) (1)

Vibration of the straw reed can be explained as follows. Numbers below correspond to numbers indicated in FIG. 6.

(1) Blowing of air increases the flow velocity inside the straw.

(2) Increase in the flow velocity decreases the pressure.

(3) Decrease in pressure causes the reed to be closed.

(4) Closing of the reed narrows the passage.

(5) Narrowing of the passage decreases the flow velocity.

(6) Decrease in the flow velocity increases the pressure to its original value.

(7) When the pressure returns to its original value, the reed opens, and the process returns to (1).

FIG. 7 illustrates an example of a relations diagram. FIG. 7 illustrates an example of a relations diagram of a mechanism of a straw reed that does not produce sound. The relations diagram is created by the relations diagram creating module 115 in accordance with a user operation.

It is assumed here that the density of air does not vary and a way of pinching the straw is not determined.

In the example in FIG. 7, items defined by rectangles are connected to each other by arrows. Upward arrows inside the item indicate that there are upward changes in the items, and downward arrows indicate that there are downward changes in the items.

Colors of the arrows connecting the items to each other indicate the polarity of cause-and-effect relations. Solid arrows connecting the items to each other indicate that there are positive correlations, and dashed arrows connecting the items to each other indicate that there are negative correlations. If an item “vibration” decreases, for example, an item “sound producibility” also decreases. In addition, levels of effects of cause-and-effect relations may be indicated by the thickness or the like of lines. These pieces of information are stored in the attribute field 1120 of the arrow information table 1100.

Although the item IDs and the arrow IDs are indicated in the relations diagram in FIG. 7, the item IDs and the arrow IDs may be hidden from the relations diagram that is actually displayed on a screen.

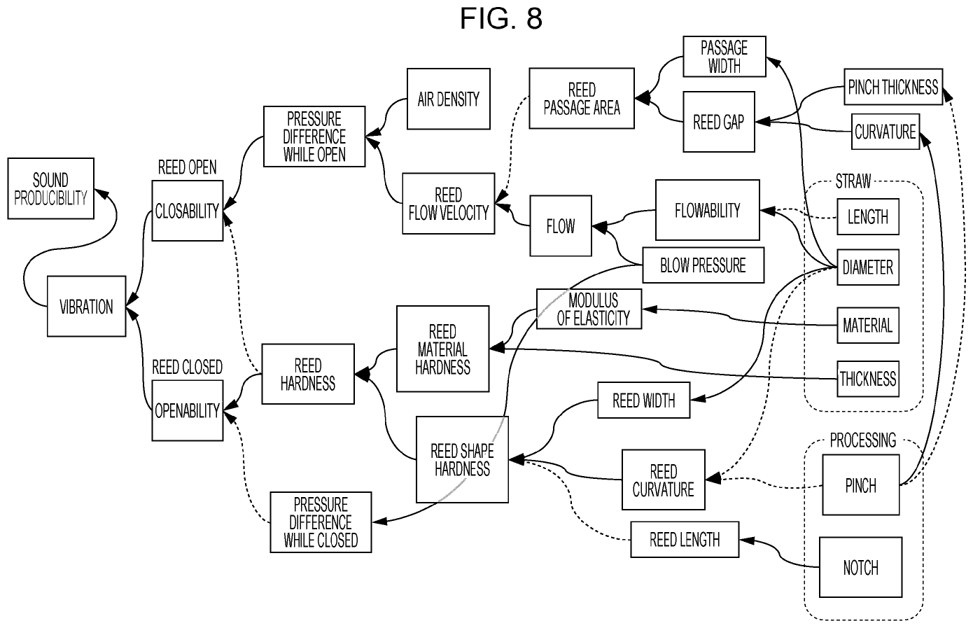

FIG. 8 illustrates another example of the relations diagram. The relations diagram illustrated in FIG. 8 is obtained by changing all the items in the relations diagram illustrated in the example in FIG. 7 to upward factors. That is, FIG. 8 illustrates an example of a relations diagram of sound producibility. As a result, some positive correlations change to negative correlations, and some negative correlations change to positive correlations, among the arrows connecting the items to each other.

FIG. 9 illustrates still another example of the relations diagram.

FIG. 9 illustrates an example in which items to be used as axes (axis items) of a spreadsheet have been selected through a user operation. Here, a first axis is quality, a second axis is a function, a third axis is a physical quantity, and a fourth axis is a design.

An item (sound producibility) 710 has been selected as the first axis.

An item (closability with reed open) 715 and an item (openability with reed closed) 720 have been selected as the second axis.

An item (reed flow velocity) 725, an item (reed material hardness) 730, an item (reed shape hardness) 735, and an item (pressure difference while open) 740 have been selected as the third axis.

An item (blow pressure) 745, an item (length) 755, an item (diameter) 760, an item (thickness) 765, an item (material) 770, an item (pinch) 780, and an item (notch) 785 have been selected as the fourth axis.

These pieces of information of the selected axes are stored in the axis field 1025 of the item information table 1000.

FIG. 10 illustrates an example of a spreadsheet. FIG. 10 illustrates a spreadsheet generated from the relations diagram illustrated in the example in FIG. 9. That is, FIG. 10 illustrates an example of a spreadsheet of the sound producibility of the straw reed.

A target of a spreadsheet is the entirety or a part of a system to be developed or designed.

A first axis (quality) 810A indicates a quality, that is, an indicator of a value of which a customer is assured. The first axis (quality) 810A is an indicator of a value obtained when a system (component) that is a target of a spreadsheet achieves a function thereof and an indicator of a value of which a customer is assured by the system or a higher system. The first axis (quality) 810A includes an axis item (sound producibility) 810.

A second axis (function) 815A indicates a role achieved by a component or a subsystem of a system in order to produce a quality. The second axis (function) 815A includes an axis item (closability with reed open) 815 and an axis item (openability with reed closed) 820.

A third axis (physical quantity) 825A indicates a physical quantity by which the function achieved by a component or a subsystem is determined. The third axis (physical quantity) 825A includes an axis item (reed flow velocity) 825, an axis item (reed material hardness) 830, an axis item (reed shape hardness) 835, and an axis item (pressure difference while closed) 840.

A fourth axis (design) 845A indicates setting conditions for controlling the physical quantity of a target component or subsystem and quantities and conditions that can be determined (to be determined) by a designer or a developer. The fourth axis (design) 845A includes an axis item (blow pressure) 845, an axis item (straw) 850, and an axis item (processing) 875. The axis item (straw) 850 includes an axis item (length) 855, an axis item (diameter) 860, an axis item (thickness) 865, and an axis item (material) 870. The axis item (processing) 875 includes an axis item (pinch) 880 and an axis item (notch) 885.

Cells (rectangles in which “VERY STRONG” or the like is written in the example illustrated in FIG. 10) whose positions are determined in adjacent axis items of a spreadsheet include cause-and-effect information. The cause-and-effect information indicates a cause-and-effect relation between two axis items. Signs “VERY STRONG”, “STRONG”, and “WEAK” indicate degrees of effects of the cause-and-effect relations, and accompanying signs “(POSITIVE)” and “(NEGATIVE)” indicate the polarity of cause-and-effect relations. That is, “(POSITIVE)” indicates a positive correlation, “(NEGATIVE)” indicates a negative correlation, “VERY STRONG (POSITIVE)” indicates a very strong positive correlation, “WEAK (POSITIVE)” indicates a weak positive correlation, “VERY STRONG (NEGATIVE)” indicates a very strong negative correlation, “WEAK (NEGATIVE)” indicates a weak negative correlation, and “-” indicates no correlation. A relation between the axis item (sound producibility) 810 and the axis item (closability with reed open) 815, for example, is “VERY STRONG (POSITIVE)”. These pieces of information reflect the attributes stored in the attribute field 1120 of the arrow information table 1100.

First, a process for outputting information indicating a part where an attribute of an arrow between a pair of items is different in the first relations diagram and the second relations diagram will be described. Note that the information indicating a part where an attribute of an arrow between a pair of items is the same may be output in the exemplary embodiment, as described above. However, the following description will be given on the assumption that the information indicating a part where an attribute of an arrow between a pair of items is different is output.

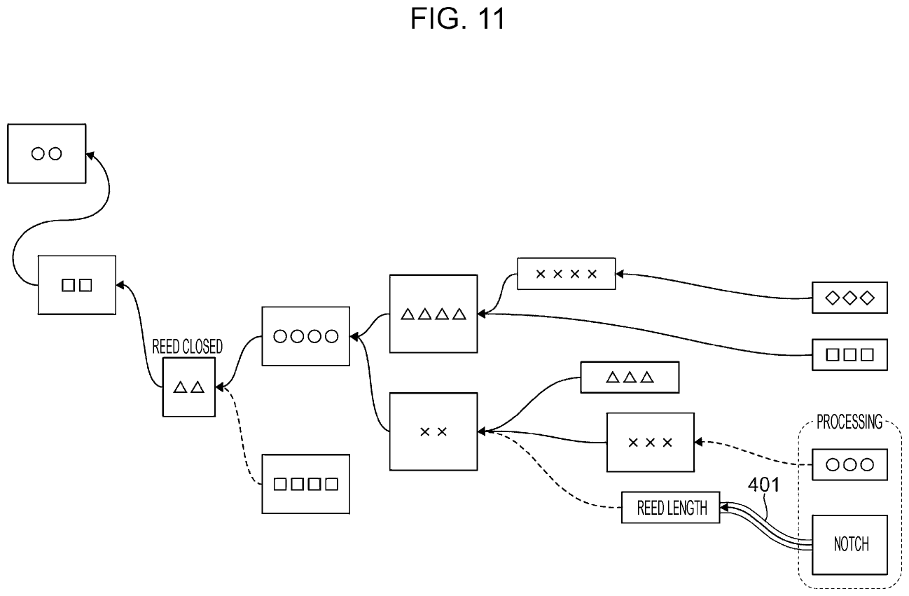

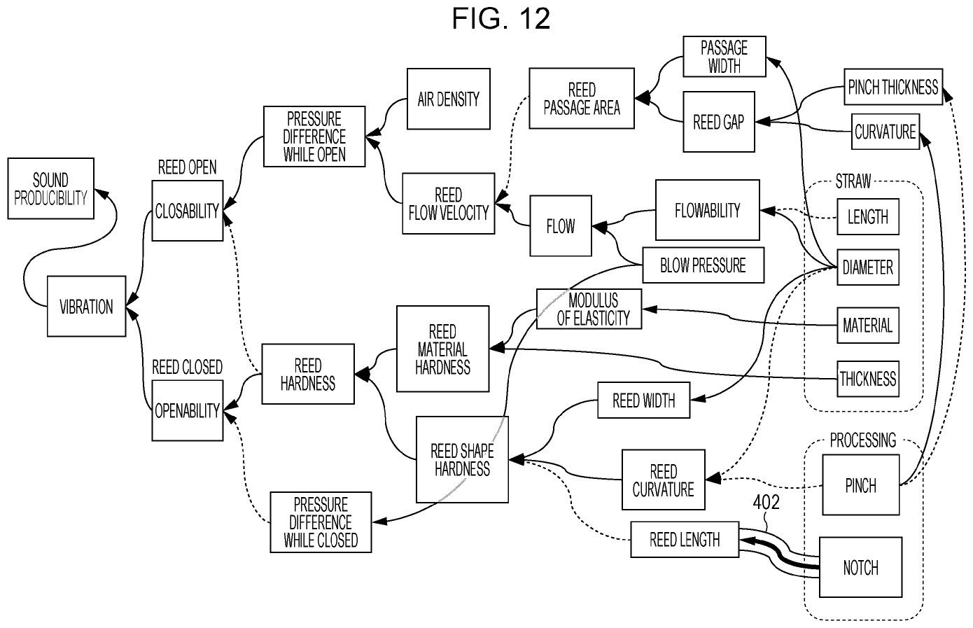

FIGS. 11 and 12 illustrate an example of a process on relations diagrams according to the exemplary embodiment.

In FIG. 11, an attribute (e.g., strength) of an arrow between an item “REED LENGTH” and an item “NOTCH” is “normal” as illustrated by an arrow having a normal thickness.

In FIG. 12, an attribute (e.g., strength) of an arrow between an item “REED LENGTH” and an item “NOTCH” is “strong” as illustrated by a thick arrow.

Thus, FIGS. 11 and 12 illustrate that the attribute (e.g., strength) of the arrow between the item “REED LENGTH” and the item “NOTCH” is different by using a display element that emphasizes the arrow. For example, the display element that emphasizes the arrow may be a tube-shape figure (tube object) that covers the arrow. A tube object 401 is displayed for the arrow between the item “REED LENGTH” and the item “NOTCH” in FIG. 11. A tube object 402 is displayed for the arrow between the item “REED LENGTH” and the item “NOTCH” in FIG. 12.

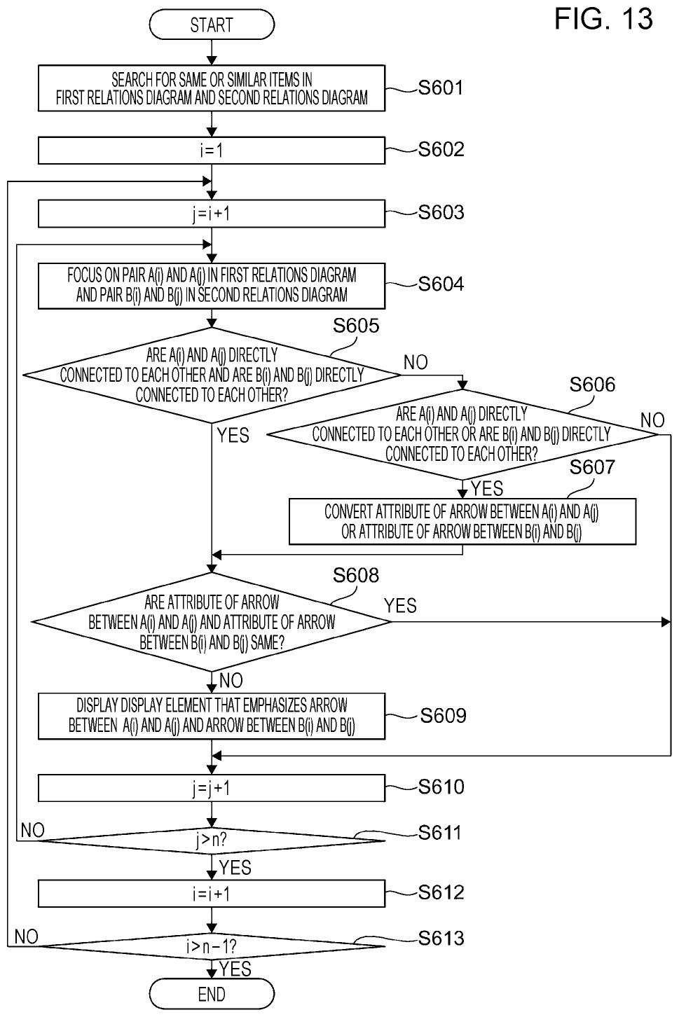

FIG. 13 is a flowchart illustrating an example of a process according to the exemplary embodiment.

First, in the information processing apparatus 100, the difference extracting module 130 searches for the same or similar items in the first relations diagram and the second relations diagram (step S601). Note that it is assumed in this example that items A(1), A(2), A(n) in the first relations diagram are respectively the same as or similar to items B(1), B(2), B(n) in the second relations diagram and that these items are found.

Subsequently, the difference extracting module 130 substitutes 1 for a variable i for counting the items in the first relations diagram (step S602), substitutes (i+1) for a variable j for counting the items in the second relations diagram (step S603), and focuses on a pair of an item A(i) and an item A(j) in the first relations diagram and a pair of an item B(i) and an item B(j) in the second relations diagram (step S604).

Subsequently, the difference extracting module 130 determines whether the item A(i) and the item A(j) in the first relations diagram are directly connected to each other and whether the item B(i) and the item B(j) in the second relations diagram are directly connected to each other (step S605). If it is determined that the item A(i) and the item A(j) are directly connected to each other and that the item B(i) and the item B(j) are directly connected to each other, the difference extracting module 130 determines whether an attribute of an arrow between the item A(i) and the item A(j) and an attribute of an arrow between the item B(i) and the item B(j) are the same (step S608). If it is not determined that the attribute of the arrow between the item A(i) and the item A(j) and the attribute of the arrow between the item B(i) and the item B(j) are the same, the output module 135 outputs a display element that emphasizes the arrow between the item A(i) and the item A(j) and the arrow between the item B(i) and the item B(j) to the relations diagrams (step S609), and the process proceeds to step S610. The display element may be any element that displays the arrow in a manner distinguished from the other arrows and is, for example, an element that causes the arrow to blink, to be displayed in a different color, to have a thicker line, to be brighter, or to be surrounded by a circle, for example.

On the other hand, if it is not determined in step S605 that the item A(i) and the item A(j) are directly connected to each other and that the item B(i) and the item B(j) are directly connected to each other, the difference extracting module 130 determines whether the item A(i) and the item A(j) are directly connected to each other or whether the item B(i) and the item B(j) are directly connected to each other (step S606). If it is determined that the item A(i) and the item A(j) are directly connected to each other or that the item B(i) and the item B(j) are directly connected to each other, the attribute of the arrow between the items that are not directly connected to each other, among the items A(i) and A(j) and the items B(i) and B(j), is converted (step S607). After this conversion process has been performed, the difference extracting module 130 determines whether the attribute of the arrow between the item A(i) and the item A(j) and the attribute of the arrow between the item B(i) and the item B(j) are the same (step S608). The conversion process in step S607 and the determination process in step S608 performed after the conversion process will be described later. If it is not determined that the attribute of the arrow between the item A(i) and the item A(j) and the attribute of the arrow between the item B(i) and the item B(j) are the same, the output module 135 outputs a display element that emphasizes the arrow between the item A(i) and the item A(j) and the arrow between the item B(i) and the item B(j) to the relations diagrams (step S609), and the process proceeds to step S610.

Note that if it is determined in step S608 that the attribute of the arrow between the item A(i) and the item A(j) and the attribute of the arrow between the item B(i) and the item B(j) are the same, or if it is determined in step S606 that the item A(i) and the item A(j) are not directly connected to each other and that the item B(i) and the item B(j) are not directly connected to each other, the output module 135 does not output a display element to the relations diagrams, and the process proceeds to step S610.

Subsequently, the difference extracting module 130 adds 1 to the variable j (step S610) and determines whether the variable j exceeds n (step S611). If it is determined that the variable j does not exceed n, the difference extracting module 130 causes the process to return to step S604; if it is determined that the variable j exceeds n, the difference extracting module 130 adds 1 to the variable i (step S612) and determines whether the variable i exceeds (n−1) (step S613). If it is determined that the variable i does not exceed (n−1), the difference extracting module 130 causes the process to return to step S603; if it is determined that the variable i exceeds (n−1), the difference extracting module 130 ends the process.

Now, the conversion process in step S607 and the determination process in step S608 performed after the conversion process will be described.

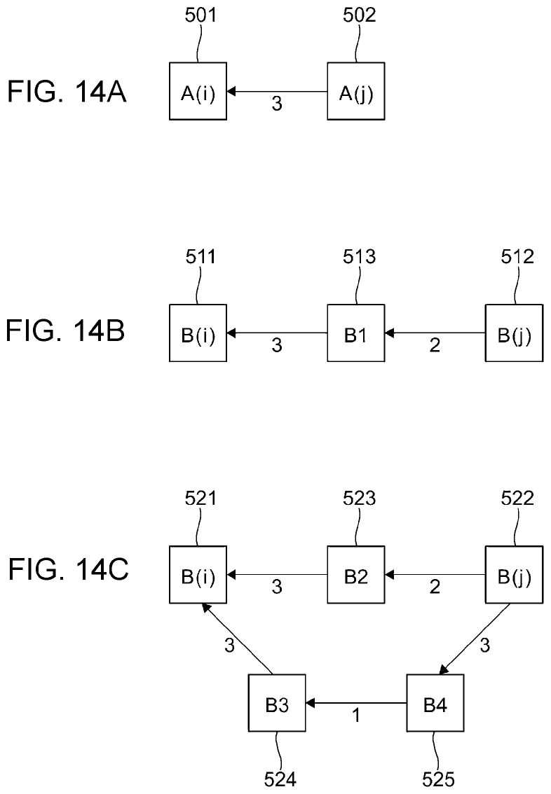

FIGS. 14A to 14C illustrate examples of the conversion process and the determination process.

FIG. 14A illustrates a part of the first relations diagram in which an item (A(i)) 501 and an item (A(j)) 502 are directly connected to each other. For example, the value of an attribute of an arrow between the item (A(i)) 501 and the item (A(j)) 502 is “3”.

FIG. 14B illustrates a part of the second relations diagram in which an item (B(i)) 511 and an item (B(j)) 512 are connected to each other via an item (B1) 513. The item (B(i)) 511 is the same as or similar to the item (A(i)) 501, and the item (B(j)) 512 is the same as or similar to the item (A(j)) 502. In a case where the items are arranged in series, a smaller value of the values of attributes of arrows is employed in step S607, and the value of the attribute of the arrow between the items in the first relations diagram and the value of the attribute employed in the second relations diagram are compared with each other in step S608.

For example, if the value of an attribute of an arrow between the item (B(i)) 511 and the item (B1) 513 is “3” and the value of an attribute of an arrow between the item (B1) 513 and the item (B(j)) 512 is “2”, in step S607, “2 (=min (3, 2))” is employed as the value of an attribute of an arrow between the item (B(i)) 511 and the item (B(j)) 512. In step S608, the value “3” of the attribute of the arrow between the item (A(i)) 501 and the item (A(j)) 502 in the first relations diagram and the value “2” of the attribute employed in the second relations diagram are compared with each other.

FIG. 14C illustrate a part of the second relations diagram in which an item (B(i)) 521 and an item (B(j)) 522 are connected to each other via an item (B2) 523 in an arrow string and via an item (B3) 524 and an item (B4) 525 in another arrow string. The item (B(i)) 521 is the same as or similar to the item (A(i)) 501, and the item (B(j)) 522 is the same as or similar to the item (A(j)) 502. In a case where the arrow strings are arranged in parallel, a larger value of the values of attributes of the arrow strings is employed in step S607, and the value of the attribute of the arrow between the items in the first relations diagram and the value of the attribute employed in the second relations diagram are compared with each other in step S608.

For example, if the value of an attribute of an arrow between the item (B(i)) 521 and the item (B2) 523 is “3”, the value of an attribute of an arrow between the item (B2) 523 and the item (B(j)) 522 is “2”, the value of an attribute of an arrow between the item (B(i)) 521 and the item (B3) 524 is “3”, the value of an attribute of an arrow between the item (B3) 524 and the item (B4) 525 is “1”, and the value of an attribute of an arrow between the item (B4) 525 and the item (B(j)) 522 is “3”, “2=max (min (3, 2), min (3, 1, 3))” is employed as the value of an attribute of an arrow between the item (B(i)) 521 and the item (B(j)) 522 in step S607. In step S608, the value “3” of the attribute of the arrow between the item (A(i)) 501 and the item (A(j)) 502 in the first relations diagram and the value “2” of the attribute employed in the second relations diagram are compared with each other.

Next, a process for outputting information indicating a part where a hierarchical structure between a pair of items is different in the first relations diagram and the second relations diagram will be described. Note that the information indicating a part where a hierarchical structure between a pair of items is the same may be output in the exemplary embodiment, as described above. However, the following description will be given on the assumption that the information indicating a part where a hierarchical structure between a pair of items is different is output.

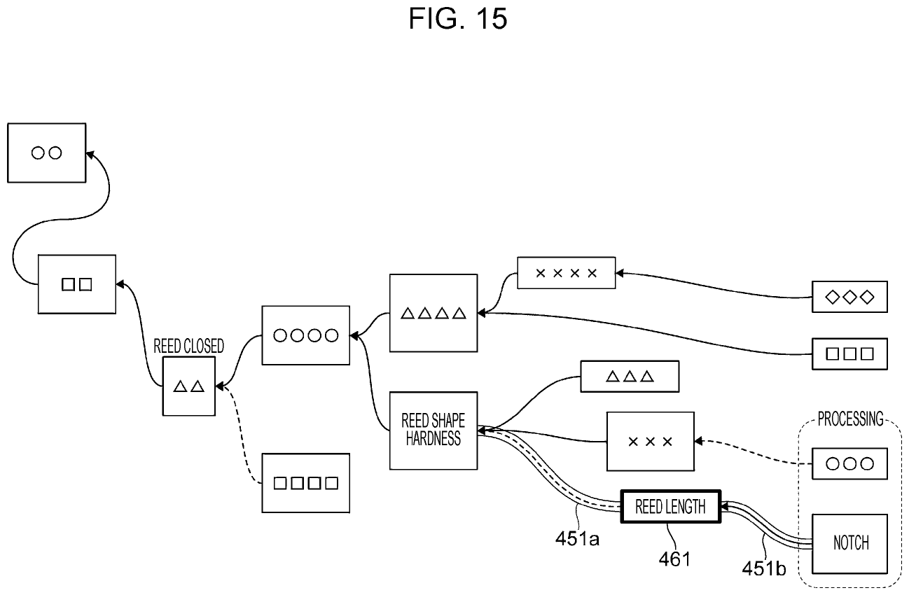

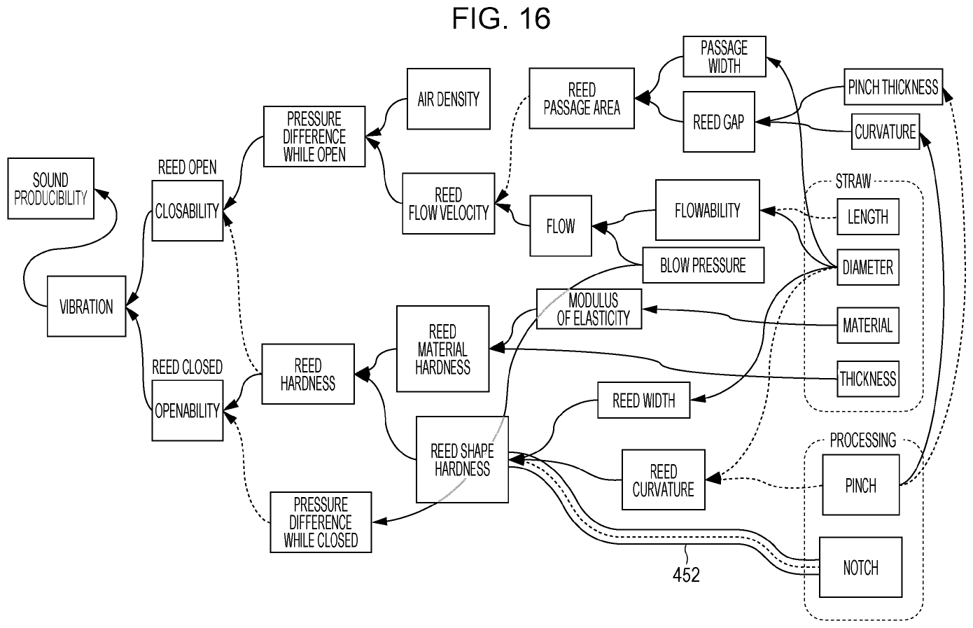

FIGS. 15 and 16 illustrate an example of a process on relations diagrams according to the exemplary embodiment.

In FIG. 15, an item “REED SHAPE HARDNESS” and an item “NOTCH” are connected to each other via an item “REED LENGTH”.

In FIG. 16, an item “REED SHAPE HARDNESS” and an item “NOTCH” are directly connected to each other.

Thus, FIGS. 15 and 16 illustrate that the hierarchical structure between the item “REED SHAPE HARDNESS” and the item “NOTCH” is different by using a display element that emphasizes an arrow between the items and a display element that emphasizes the intermediate item. For example, the display element that emphasizes the arrow may be a tube-shape figure (tube object) that covers the arrow, and the display element that emphasizes the intermediate item may be a frame-shape figure (frame object) that surrounds the intermediate item. In FIG. 15, a tube object 451a is displayed for an arrow between the item “REED SHAPE HARDNESS” and the item “REED LENGTH”, a tube object 451b is displayed for an arrow between the item “REED LENGTH” and the item “NOTCH”, and a frame object 461 is displayed for the intermediate item “REED LENGTH”. In FIG. 16, a tube object 452 is displayed for an arrow between the item “REED SHAPE HARDNESS” and the item “NOTCH”.

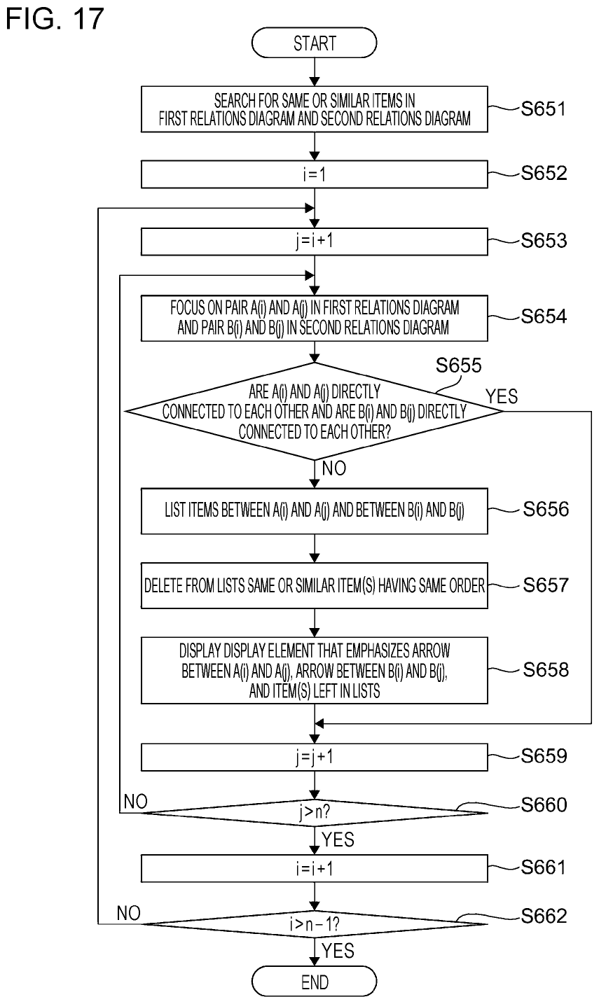

FIG. 17 is a flowchart illustrating an example of a process according to the exemplary embodiment.

First, in the information processing apparatus 100, the difference extracting module 130 searches for the same or similar items in the first relations diagram and the second relations diagram (step S651). Note that it is assumed in this example that items A(1), A(2), . . . , A(n) in the first relations diagram are respectively the same as or similar to items B(1), B(2), . . . , B(n) in the second relations diagram and that these items are found.

Subsequently, the difference extracting module 130 substitutes 1 for a variable i for counting the items in the first relations diagram (step S652), substitutes (i+1) for a variable j for counting the items in the second relations diagram (step S653), and focuses on a pair of the item A(i) and the item A(j) in the first relations diagram and a pair of the item B(i) and the item B(j) in the second relations diagram (step S654).

Subsequently, the difference extracting module 130 determines whether the item A(i) and the item A(j) in the first relations diagram are directly connected to each other and whether the item B(i) and the item B(j) in the second relations diagram are directly connected to each other (step S655). If it is not determined that the item A(i) and the item A(j) are directly connected to each other and that the item B(i) and the item B(j) are directly connected to each other, that is, if it is determined that the item A(i) and the item A(j) are not directly connected to each other or that the item B(i) and the item B(j) are not directly connected to each other, the difference extracting module 130 lists an item(s) between the item A(i) and the item A(j) and lists an item(s) between the item B(i) and the item B(j) (step S656). Subsequently, the difference extracting module 130 compares the list of the item(s) between the item A(i) and the item A(j) created in step S656 and the list of the item(s) between the item B(i) and the item B(j) created in step S656 with each other, and if there is the same or similar item(s) having the same order in the lists, deletes the item(s) from the lists (step S657). At this time, if there is only one item that is the same or similar in the lists, the item is deleted from the lists regardless of the order. If there are a plurality of items that are the same or similar in the lists, these items are deleted from the lists as long as the items have the same order. The expression “having the same order” herein means the same order of arrangement in a direction from one item to another, which are included in the plurality of items that are the same or similar. An item(s) is left in the lists as a result of deletion of the item(s) in step S657. The output module 135 outputs a display element that emphasizes an arrow between the item A(i) and the item A(j) and an arrow between the item B(i) and the item B(j) and a display element that emphasizes the left item(s) to the relations diagrams (step S658), and the process proceeds to step S659.

On the other hand, if it is determined in step S655 that the item A(i) and the item A(j) are directly connected to each other and that the item B(i) and the item B(j) are directly connected to each other, the output module 135 does not output a display element to the relations diagrams, and the process proceeds to step S659.

Subsequently, the difference extracting module 130 adds 1 to the variable j (step S659) and determines whether the variable j exceeds n (step S660). If it is determined that the variable j does not exceed n, the difference extracting module 130 causes the process to return to step S654; if it is determined that the variable j exceeds n, the difference extracting module 130 adds 1 to the variable i (step S661) and determines whether the variable i exceeds (n−1) (step S662). If it is determined that the variable i does not exceed (n−1), the difference extracting module 130 causes the process to return to step S653; if it is determined that the variable i exceeds (n−1), the difference extracting module 130 ends the process.

Now, the list process in step S656 and the item deletion process for deleting the items from the lists in step S657 will be described.

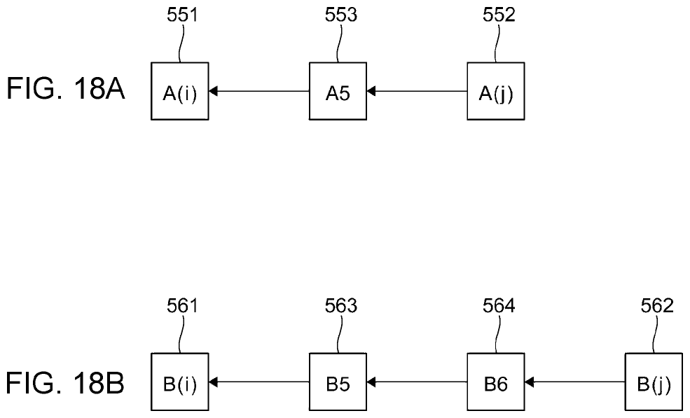

FIGS. 18A and 18B illustrate an example of the list process and the item deletion process.

FIG. 18A illustrates a part of the first relations diagram in which an item (A(i)) 551 and an item (A(j)) 552 are connected to each other via an item (A5) 553.

FIG. 18B illustrates a part of the second relations diagram in which an item (B(i)) 561 and an item (B(j)) 562 are connected to each other via an item (B5) 563 and an item (B6) 564. The item (B(i)) 561 is the same as or similar to the item (A(i)) 551, and the item (B(j)) 562 is the same as or similar to the item (A(j)) 552.

For example, a list {A5} of the item between the item (A(i)) 551 and the item (A(j)) 552 and a list {B5, B6} of the items between the item (B(i)) 561 and the item (B(j)) 562 are created in step S656. If the item (A5) 553 and the item (B5) 563 are the same or similar in this example, in step S608, “A5” is deleted from the list {A5} of the item between the item (A(i)) 551 and the item (A(j)) 552, and “B5” is deleted from the list {B5, B6} of the items between the item (B(i)) 561 and the item (B(j)) 562. As a result, an item left in the lists is only “B6”, which is the item between the item (B(i)) 561 and the item (B(j)) 562.

In the above description, in a case where there are a plurality of parts where an attribute of an arrow or a hierarchical structure is the same in the first relations diagram and the second relations diagram, or in a case where there are a plurality of parts where an attribute of an arrow or a hierarchical structure is different in the first relations diagram and the second relations diagram, information indicating the plurality of parts is directly output. However, the present disclosure is not limited to this example, and information indicating at least one part that is selected from among the plurality of parts may be output. As the at least one part, a part that is related to an item specified by a user may be selected, or a part corresponding to an attribute of an arrow or a hierarchical structure specified by a user may be selected. In this case, the plurality of parts where an attribute of an arrow or a hierarchical structure is the same or the plurality of parts where an attribute of an arrow or a hierarchical structure is different in the first relations diagram and the second relations diagram are examples of a plurality of results of comparison between a plurality of relations of a first item group and a plurality of relations of a second item group, the first item group being included in the plurality of items in the first relations diagram, the second item group being included in the plurality of items in the second relations diagram, the second item group being the same as or similar to the first item group. The at least one part that is selected is an example of at least one result that is selected.

In the above description, a part where an attribute of an arrow or a hierarchical structure is the same in the first relations diagram and the second relations diagram, or a part where an attribute of an arrow or a hierarchical structure is different in the first relations diagram and the second relations diagram is output. However, the present disclosure is not limited to this example, and a part where an attribute of an arrow or a hierarchical structure is similar in the first relations diagram and the second relations diagram may be output.

The expression “an attribute of an arrow is similar” means, for example, that at least one of attributes of arrows is similar, or that at least one of attributes of arrows is different but the other attributes are the same. In a first example, the strength of an arrow differs by one or two stages, but the arrow is directed in the same direction. In a second example, an arrow is directed in the opposite direction, but has the same strength.

In addition, the expression “a hierarchical structure is similar” means, for example, that M2/M1 is less than a predetermined threshold (greater than zero) where M1 is a number of the same or similar items in a list of items between a pair of items in the first relations diagram and in a list of items between a pair of items in the second relations diagram and where M2 is a number of items that are included in one of the lists but whose same or similar items are not included in the other list. Thus, if the predetermined threshold is 0.4, for example, in a case where the list of items between the item A(i) and the item A(j) in the first relations diagram is {A11, A12, A13, A14, A15, A16}, where the list of items between the item B(i) and the item B(j) in the second relations diagram is {B11, B12, B13, B14, B15}, and where items A11, A12, A13, A14, and A15 and the items B11, B12, B13, B14, and B15 are the same or similar, respectively, the hierarchical stricture is “similar”. In addition, in a case of FIGS. 18A and 18B, for example, the hierarchical stricture is “different”.

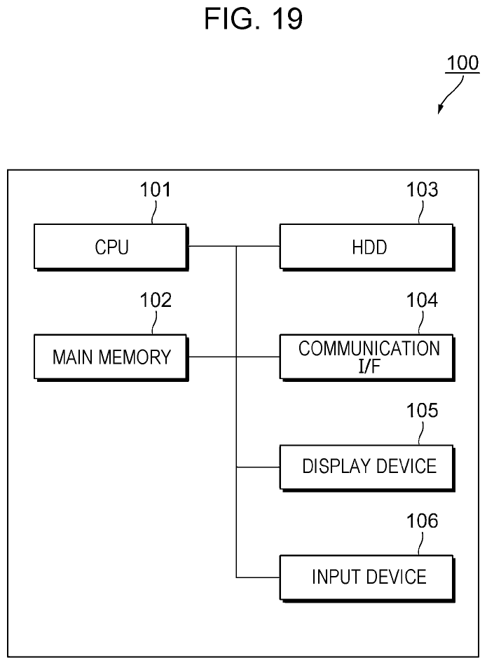

FIG. 19 illustrates an example of a hardware configuration according to the exemplary embodiment.

The information processing apparatus 100 includes a CPU 101 that is a computation means and a main memory 102 and a hard disk drive (HDD) 103 that are storage means. Note that the CPU 101 executes an operating system (OS) and various kinds of software such as applications to realize the above-described processing modules. In addition, the main memory 102 stores the various kinds of software and data, for example, to be used for their execution, and the HDD 103 stores data to be input to the various kinds of software, data output from the various kinds of software, for example. Either one or both of them realize the storing modules. The information processing apparatus 100 further includes a communication interface (communication I/F) 104 for external communication, a display device 105 such as a display, and an input device 106 such as a keyboard or a mouse.

The process performed by the information processing apparatus 100 in the exemplary embodiment is prepared, for example, as a program such as application software.

That is, a program that realizes the exemplary embodiment is also regarded as a program that enables a computer to implement: a function of acquiring a first relations diagram and a second relations diagram in each of which a plurality of items are connected to each other via arrows to represent relations between the plurality of items; and a function of outputting notification information that is a notification of a result of comparison between a first relation and a second relation, the first relation being a relation between a first pair of items included in the plurality of items in the first relations diagram, the second relation being a relation between a second pair of items included in the plurality of items in the second relations diagram, the second pair of items being the same as or similar to the first pair of items.

Note that the program realizing the exemplary embodiment may be provided by a communication means or may be provided by being stored in a recording medium such as a CD-ROM.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an acquisition unit that acquires a first relations diagram and a second relations diagram in each of which a plurality of items are connected to each other via arrows to represent relations between the plurality of items; and
an output unit that outputs notification information that is a notification of a result of comparison between a first relation and a second relation, the first relation being a relation between a first pair of items included in the plurality of items in the first relations diagram, the second relation being a relation between a second pair of items included in the plurality of items in the second relations diagram, the second pair of items being the same as or similar to the first pair of items.

2. The information processing apparatus according to claim 1, wherein the notification information includes first notification information that is a notification stating that the first relation and the second relation are the same.

3. The information processing apparatus according to claim 2, wherein the first notification information is information that is a notification stating that an attribute of an arrow between the first pair of items and an attribute of an arrow between the second pair of items are the same.

4. The information processing apparatus according to claim 2, wherein the first notification information is information that is a notification stating that a structure of an arrow between the first pair of items and a structure of an arrow between the second pair of items are the same.

5. The information processing apparatus according to claim 4, wherein the structure of the arrow is a number and an attribute of items connected to each other via the arrow.

6. The information processing apparatus according to claim 1, wherein the notification information includes second notification information that is a notification stating that the first relation and the second relation are different from each other.

7. The information processing apparatus according to claim 6, wherein the second notification information is information that is a notification stating that an attribute of an arrow between the first pair of items and an attribute of an arrow between the second pair of items are different from each other.

8. The information processing apparatus according to claim 6, wherein the second notification information is information that is a notification stating that a structure of an arrow between the first pair of items and a structure of an arrow between the second pair of items are different from each other.

9. The information processing apparatus according to claim 8, wherein the structure of the arrow is a number of items connected to each other by the arrow.

10. The information processing apparatus according to claim 8, wherein the structure of the arrow is an attribute of items connected to each other by the arrow.

11. The information processing apparatus according to claim 1, wherein the notification information is information that is a notification of at least one result selected from among a plurality of results of comparison between a plurality of relations of a first item group and a plurality of relations of a second item group, the first item group being included in the plurality of items in the first relations diagram, the second item group being included in the plurality of items in the second relations diagram, the second item group being the same as or similar to the first item group.

12. A non-transitory computer readable medium storing a program causing a computer to execute a process for information processing, the process comprising:
acquiring a first relations diagram and a second relations diagram in each of which a plurality of items are connected to each other via arrows to represent relations between the plurality of items; and
outputting notification information that is a notification of a result of comparison between a first relation and a second relation, the first relation being a relation between a first pair of items included in the plurality of items in the first relations diagram, the second relation being a relation between a second pair of items included in the plurality of items in the second relations diagram, the second pair of items being the same as or similar to the first pair of items.

13. An information processing apparatus comprising:
acquisition means for acquiring a first relations diagram and a second relations diagram in each of which a plurality of items are connected to each other via arrows to represent relations between the plurality of items; and
output means for outputting notification information that is a notification of a result of comparison between a first relation and a second relation, the first relation being a relation between a first pair of items included in the plurality of items in the first relations diagram, the second relation being a relation between a second pair of items included in the plurality of items in the second relations diagram, the second pair of items being the same as or similar to the first pair of items.
